(19) United States
(12) Patent Application Publication
(10) Pub. No.: US 2016/0239268 A1
(43) Pub. Date: Aug. 18, 2016

(54) ADDING APPARATUS USING TIME INFORMATION AND A METHOD THEREOF

(71) Applicant: Korea Advanced Institute of Science and Technology, Daejeon (KR)

(72) Inventors: Seong Hwan CHO, Daejeon (KR); Dong In KIM, Daejeon (KR)

(21) Appl. No.: 14/621,016

(22) Filed: Feb. 12, 2015

(51) Int. Cl. G06F 7/508

(52) U.S. Cl. CPC G06F 7/508

(57) ABSTRACT

An adding apparatus according to an example of the present invention comprises: a time adder for outputting a time addition signal using time information of the first input signal and time information of the second input signal, if a first input signal synchronized according to a unit time delay and a second input signal synchronized with the unit time delay; and a carry digit processor for outputting a carry generation signal by conducting a carry-lookahead operation corresponding to the time addition signal according to the unit time delay.

### BACKGROUND OF THE INVENTION

1. Technical Field

The present invention relates to an adding apparatus and a method thereof, more specifically, an adding apparatus using time information and a method thereof.

2. Description of the Related Art

With the recent development of semiconductor process technology, a supply voltage of a circuit has been lowered, and characteristics of MOSFET, a discrete device, have been deteriorated. Accordingly, it is increasingly difficult to design a circuit using a conventional voltage-based signal process. Recently, as an alternative circuit design method, more research for a time-based signal process has been carried out. A time-based signal process is a technology for processing a signal by converting an input signal into a space between two edges on a time axis or a width of a single pulse.

Specifically, through such constitution, N-bit expression per wire is available in the time-based expression, although only 1-bit expression per wire was available in the conventional digital-based expression. In this mode, such expression is available by adjusting the occurrence time of rising edge on the time axis.

As such, there is a need for a research on performance improvement of clock synchronized time operation as well as a research on a time-based operation circuit. Specifically, as a circuit production process has been developed, an importance of power consumption occurring in the process of information propagation has been emphasized, and it has been a main issue to seek for solution.

However, it is currently difficult to achieve such objective, because an operation method and a circuit design for easily conducting a time information-based operation have not yet been developed. Thus, it is significantly difficult to design a time operation apparatus that can be used under substantial industrial environments.

### SUMMARY OF THE INVENTION

In order to solve the aforesaid problem, the present invention aims to provide an adding apparatus and a method of adding for conducting an easy and efficient addition, specifically, with respect to multi bit and achieving a precise carry digit processing by storing time information according to a unit time delay using a time register.

The adding apparatus using time information according to the example of the present invention to solve the aforesaid problem comprises: a time adder for outputting a time addition signal using time information of the first input signal and time information of the second input signal, if a first input signal synchronized according to a unit time delay and a second input signal synchronized with the unit time delay are applied; and a carry digit processor for conducting a carry-lookahead operation corresponding to the time addition signal according to the unit time delay to output a carry generation signal.

The method of adding using time information according to the example of the present invention to solve the aforesaid problem comprises the steps of: outputting a time addition signal using time information of the firsts input signal and time information of the second input signal, if a first input signal synchronized according to a unit time delay and a second input signal synchronized with the unit time delay are applied; and conducting a carry-lookahead operation corresponding to the time addition signal according to the unit time delay to output a carry generation signal.

The method according to the example of the present invention to solve the aforesaid problem may be achieved by a recording medium recording a program executed in a computer.

### BRIEF DESCRIPTION OF THE DRAWINGS

FIG. 1 schematically illustrates an adding apparatus according to an example of the present invention.

FIGS. 2(A) and 2(B) illustrate a multi-bit value input indicated as a time-based signal according to an example of the present invention.

FIG. 3 more specifically illustrates an adding apparatus according to an example of the present invention.

FIG. 4 and FIG. 5 illustrate embodiments of circuits of a time adder and a reference adder according to the example of the present invention and examples of the input signal according thereto.

FIG. 6 is a flow chart illustrating a method of adding according to an example of the present invention.

### DESCRIPTION OF THE PREFERRED EMBODIMENTS

The following content merely instantiates the principle of the present invention. Accordingly, those skilled in the art can invent various apparatuses that achieve the principle of the present invention and are included in the concept and scope of the present invention, which are not explicitly explained or disclosed in the specification of the subject application. Further, all conditional terms and examples disclosed in the specification of the subject application are explicitly intended only for purposes of assisting the understanding of the concept of the present invention, and should not be limited to the specifically listed examples and states.

Further, all the detailed descriptions disclosing specific examples as well as the principle, perspective and examples of the present invention, should be understood to be intended to include structural and functional equivalents thereof. These equivalents should also be understood to include equivalents to be developed in the future as well as the currently disclosed equivalents, i.e., all devices invented to perform the same function regardless of the structure.

Accordingly, for example, the block diagram in the specification of the subject application should be understood to represent a conceptual perspective of an exemplified circuit that embodies the principle of the present invention. Similarly, all flow charts, state transition diagrams and pseudo codes can be substantially presented in a computer-readable medium, and should be understood to represent various processes performed by a computer or a processor regardless of whether a computer or a processor is explicitly disclosed.

The function of various devices shown in the drawings including a function block indicated by a process or a similar concept thereof can be provided by the use of an exclusive hardware or a hardware having capacity to execute a software associated with an appropriate software. When provided by a processor, such function can be provided by a single exclusive processor, a single shared processor or a plurality of individual processors, some of which can be shared.

Further, the use of terms that are presented by a processor, control or a similar concept thereof should not be construed by exclusively referring to a hardware having capacity to execute a software, but should be understood to allusively include a digital signal processor (DSP) hardware, a ROM for storing a software, RAM and a non-volatile memory without restrictions. The other well-known and commonly used hardware may be included.

The components in the claims, which are expressed as means for performing the function described in the specification, are intended to include all methods for performing the function of all types of software including a combination of the circuit devices for performing the aforesaid function or a firmware/micro code, and are combined with appropriate circuits for executing the software to perform the aforesaid function. The present invention defined by such claims are combined with the functions provided by variously listed means and the methods required by the claims, and thus, any means for providing the aforesaid function should be understood to be equivalent to what is grasped from the specification.

The aforesaid objective, features and advantages will be more apparent through the following detailed description related to the attached drawings, and therefore, those skilled in the art can readily carry out the technical idea of the present invention. Further, when describing the present invention, a detailed description of known techniques related to the present invention, which is determined to unnecessarily obscure the gist of the present invention, is omitted.

With reference to the attached drawings, various examples of the present invention will be described in detail.

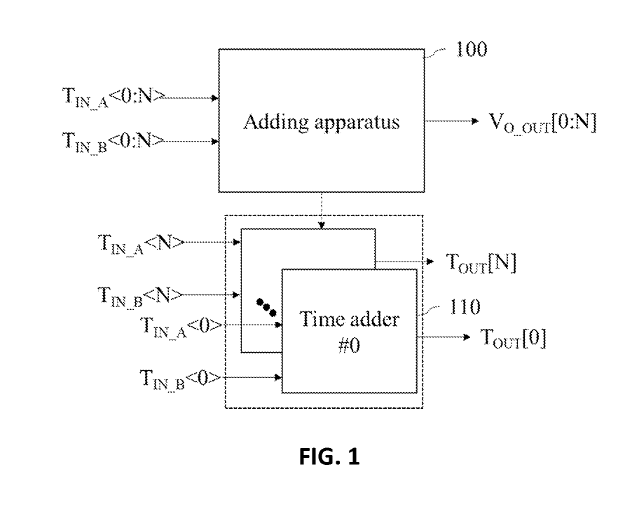

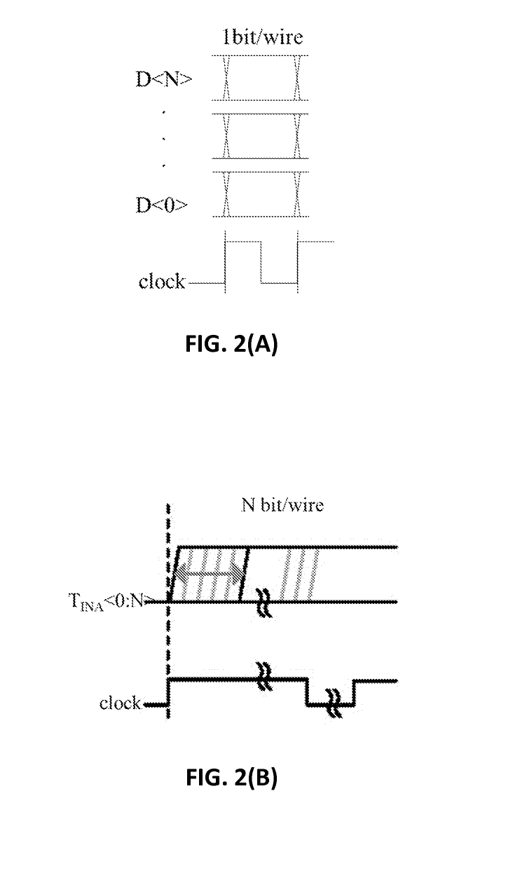

FIG. 1 schematically illustrates an adding apparatus according to the example of the present invention. FIGS. 2(A) and 2(B) illustrate a multi-bit value input indicated as a time-based signal according to the example of the present invention.

Referring to FIG. 1, an adding apparatus 100 according to the example of the present invention receives a first input signal (T_{IN}_{_}_{A}) and a second input signal (T_{IN}_{_}_{B}) wherein each input signal indicates a multi-bit value according to a unit time delay (T_{D}), and outputs an output signal (Vo_OUT) according to the time addition result of the first input signal and the second input signal.

To this end, the adding apparatus 100 may comprise at least one time adder 110 for time addition in each digit number. The at least one time adder 110 can operate time addition in respect of the first input signal and the second input signal in each digit number, and output a time addition signal (T_out) in each digit number based on the results.

In the adding apparatus 100 according to the example of the present invention, the first input signal and the second input signal may be inputted through one wire, respectively. That is, as illustrated in FIG. 2(A), a 1-bit expression per wire was available in the conventional digital-based expression, and N-number of wires was required to indicate N-bit. However, in the case of the input signal according to the example of the present invention, information transmission of N bit <0:N> is available through a voltage change of one wire, respectively.

Further, the first input signal and the second input signal in an example can indicate multi-bit values according to the time of the occurrence of voltage rising edge on the time axis and the unit time delay. To this end, the first input signal and the second input signal can be inputted for integer multiple in response to the multi bit.

The time adder 110 performs the time addition based on the unit time delay in each digit number if the first input signal and the second input signal are applied, and can output the time added signal (T_out[N]) in each digit number as a result. The adding apparatus 100 can output the time added signal (Vo_out[0:N]) in respect of the multi bit based on the time added signal in each digit number.

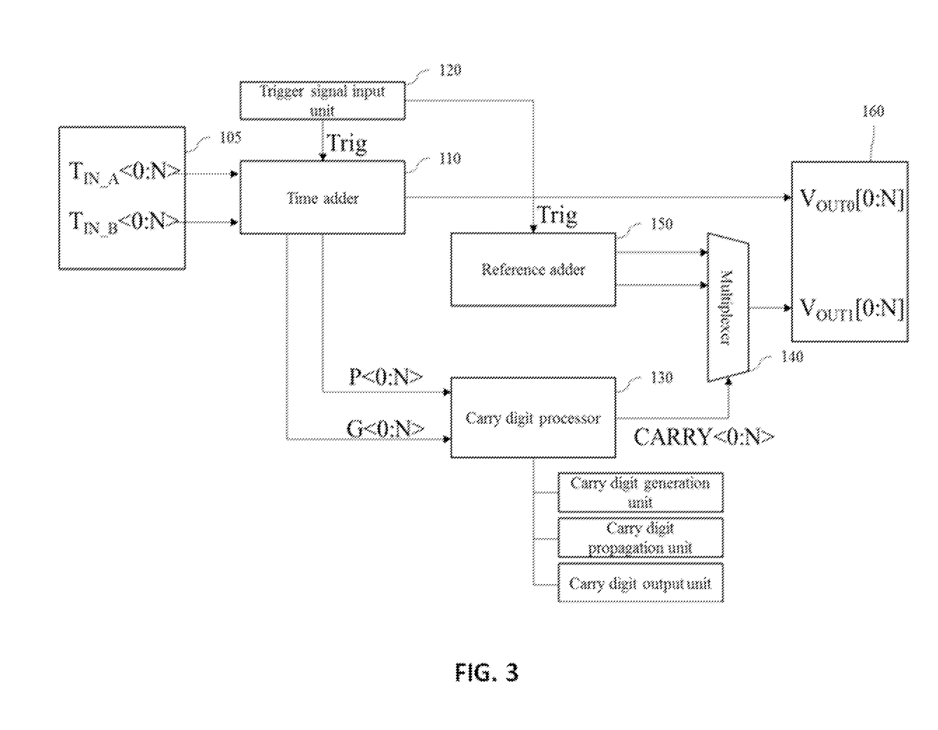

FIG. 3 illustrates the adding apparatus according to the example of the present invention in more detail.

Referring to FIG. 3, the adding apparatus 100 according to the example of the present invention comprises an input unit 105, a trigger signal input unit 120, at least one time adder 110, a carry digit processor 130, a multiplexer 140, a reference adder 150 and an output unit 160.

The input unit 105 applies a first input signal (T_{IN}_{_}_{A}) synchronized according to a unit time delay (T_{D}) and a second input signal (T_{IN}_{_}_{B}) synchronized with the unit time delay to the time adder 110. Each of the first input signal and the second input signal can indicate a predetermined multi bit value in response to the integer multiple of the unit time delay value, and each multi bit value can be an object to be added by the adding apparatus 100 according to the example of the present invention.

Further, the input unit 105 can convert the digital signal inputted from the outside into the first input signal or the second input signal synchronized with the unit time delay and can apply it to the time adder 110. For example, if a digital signal inputted from the outside, which is an object for time addition, indicates a digital-based value, as illustrated in FIG. 2(A), the input unit 105 can convert the digital signal into the first input signal or the second input signal through a digital-time conversion, and thus, apply it to the time adder 110.

Meanwhile, the time adder 110 conducts the addition using time information of the first input signal and time information of the second input signal and output a time addition signal (V_out0 based on the addition result. The time addition signal may indicate information of a sum of each digit number of multi bit.

As stated above, at least one time adder 110 may be provided based on the digit number of the first input signal and the second digit signal.

Further, the time adder 110 may comprise at least one time register for adding and accumulating time information of the first input signal and time information of the second input signal. Specifically, the time adder 110 can accurately conduct the operation in each digit number by comprising a time register having a unit time delay, which is synchronized with the unit time delay of the first input signal and the second input signal, and other logic operation circuits.

The time adder 110 conducts the time addition operation according to the unit time delay, and thus, can transmit a carry digit generation signal or a carry digit propagation signal obtained in response to the time addition signal to a carry digit predictor 130.

Meanwhile, the carry digit predictor 130 conducts a carry-lookahead operation corresponding to the time addition signal according to the unit time delay and outputs a carry generation signal (CARRY<0:N>).

To this end, the carry digit processor 130 may comprise: a carry digit generation unit for processing and outputting a carry digit generation value (G) according to the unit time delay obtained from the time addition operation of the time adder; a carry digit propagation unit for processing and outputting the carry digit propagation value (P) according to the carry digit propagation signal obtained from the time addition operation of the time adder according to the unit time delay; and a carry digit output unit for outputting the carry generation signal corresponding to the time addition signal based on the carry digit generation value and the carry digit propagation value.

The carry digit processor 130 according to the example of the present invention, as configured above, can solve the difficulty in predicting the carry digit, which occurs because one wire can indicate information of various bits.

To this end, the aforesaid unit time delay value of the first input signal and the second input signal is synchronized with the unit time delay value of the time adder 110, and therefore, the carry digit processor 130 can accurately generate and process the carry digit generation value (G) indicating the carry digit generation information and the carry digit propagation value (P) indicating the carry digit propagation information.

The carry digit output unit of the carry digit processor 130 can predict whether a carry digit in each bit is generated using the generated carry digit generation value G and the carry digit propagation value P and generate and output a carry generation signal.

The generated carry generation signal can be applied to the multiplexer 140. According to the carry generation signal, the multiplexer 140 can select an output signal of a reference adder 150.

The reference adder 150 outputs a carry digit signal (V_out1 in each bit, which is based on the carry generation signal according to the unit time delay, based on a reference voltage, and can output a first reference signal and a second reference signal delaying the first reference signal according to the unit time delay. For example, the first reference signal has a predetermined reference voltage or a ground (GND) voltage, and the second reference signal may have a complementary voltage corresponding thereto.

The multiplexer 140 selects any one of the outputs of the first reference signal and the second reference signal according to the carry generation signal and outputs a carry digit signal (V_out1 corresponding to the time addition signal.

Meanwhile, the output unit 160 outputs a time addition signal (V_out0[0:N]) or a carry digit signal (V_out1[0:N]) according to the multi-bit addition operation to the outside. The output signal of the output unit 160, as stated above, has time information indicating a multi-bit value according to the unit time delay, and thus, the number and the area of the wires connected thereto can be significantly reduced in comparison to the conventional digital adder

Further, in order to communicate with the conventional digital circuit, the output unit 160 may further comprise a time-digital converter for outputting a digital-converted multi-bit addition signal according to the time addition signal or the carry digit signal.

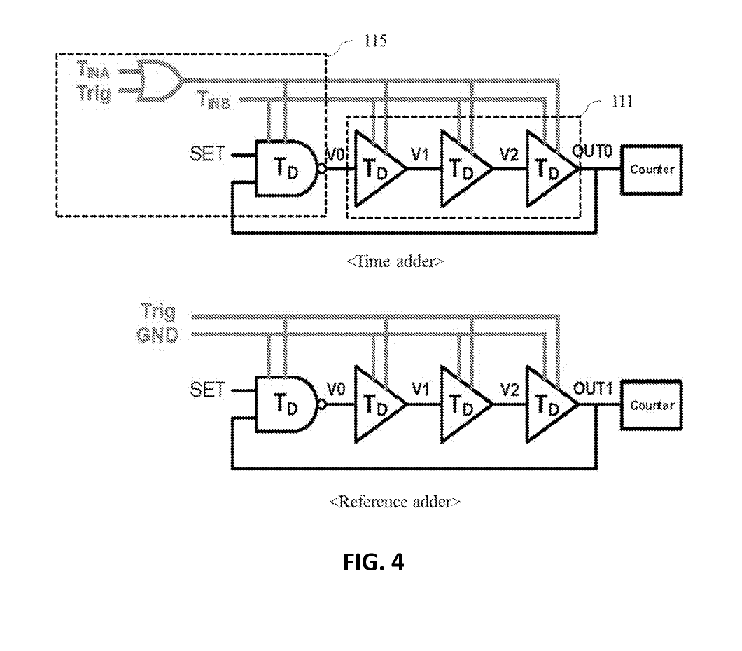

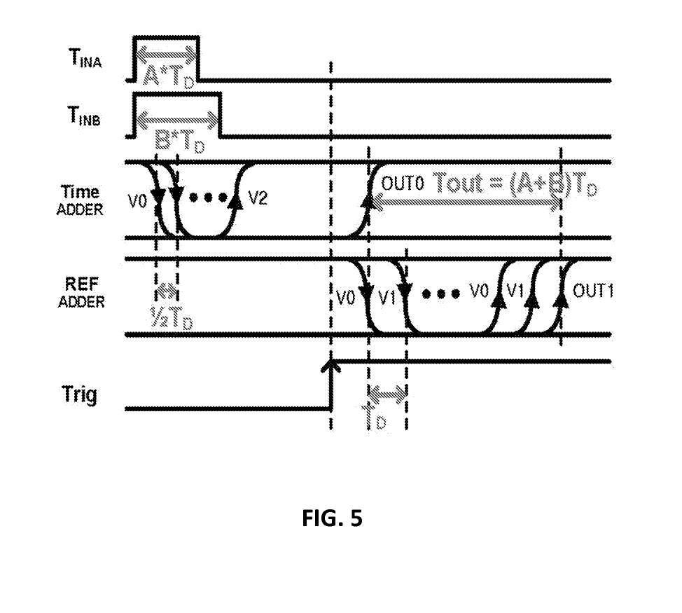

FIG. 4 and FIG. 5 illustrate embodiments of the circuits of the time adder and the reference adder according to the example of the present invention and the examples of the input and output signals according thereto.

As illustrated in FIG. 4, the time adder 110 may comprise a logic operation circuit 115 and at least one time register 111. The logic operation circuit 115 and the at least one time register 111 can conduct a unit time delay (T_{D}) processing synchronized by the counter. The addition of time information in each bit and the unit time delay processing can be conducted by the addition operation and the time delay movement of the logic operation circuit 115 and the at least one time register 111.

Further, as illustrated in FIG. 4, the reference adder 150 can output a first reference output signal and a second reference output signal according to the selection signal outputted from the carry digit processor 130 to the multiplexer 140. The second reference output can have an output delayed by a unit time delay value in comparison to the first reference output. To this end, the reference adder 150 also may comprise at least one time register for the unit time delay.

FIG. 5 illustrates a timing diagram indicating outputs of the time adder 110 and the reference adder 150 in the case that input signals T_{INA} and T_{INB} based on the unit time delay (T_{D}) are given.

Referring to FIG. 5, as each addition processor is concurrently conducted during the time that T_{INA} having time information of A and T_{INB} having time information of B are concurrently applied to the time adder 110, the unit time delay may occur twice faster (T_{D}/2) than normal.

The time adder 110 can output the time added signal (Tout=(A+B)*T_{D}) added by accumulating time information of A and time information of B. Further, the reference adder 150 can output a carry digit signal according to the time addition.

The polarity of the time added signal (Tout) according to the time information accumulation may be reversed, and thus, the output unit 160 can be converted into an output having the same polarity as the polarity of the input using the output of the reference adder 150.

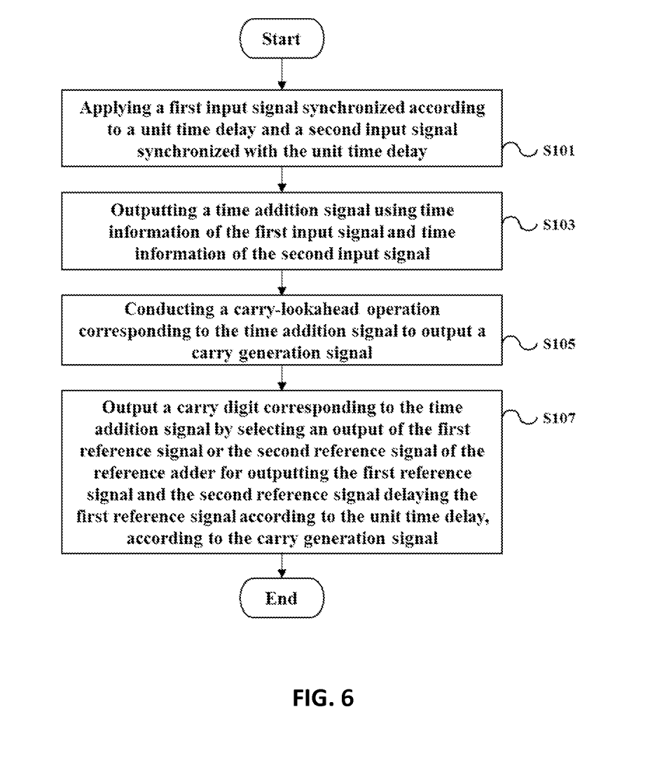

FIG. 6 is a flow chart illustrating a method of adding according to the example of the present invention.

Referring to FIG. 6, if the first input signal synchronized according to the unit time delay and the second input signal synchronized with the unit time delay are applied (S101, the adding apparatus 100 outputs a time addition signal using time information of the first input signal and time information of the second input signal (S103).

As stated above, the time adder 110 can conduct a time addition operation based on the first input signal and the second input signal applied through the input unit 105, and output the time addition signal to the output unit 160 based on the results.

The adding apparatus 100 conducts a carry-lookahead operation corresponding to the time addition signal according to the unit time delay and outputs a carry generation signal (S105.

The carry digit processor 130 can conduct the carry-lookahead operation corresponding to the time addition signal according to the time addition operation and output the carry generation signal to the multiplexer 140.

In order to output the carry generation signal, the carry digit processor 130 outputs the carry digit generation value obtained from the time addition operation of the time adder according to the unit time delay, outputs the carry digit propagation value obtained from the time addition operation of the time adder according to the unit time delay and outputs the carry generation signal corresponding to the time addition signal based on the carry digit generation value and the carry digit propagation value.

Thereafter, according to the carry generation signal, the carry digit processor selects an output of the first reference signal or the second reference signal of the reference adder 150 for outputting the first reference signal and the second reference signal delaying the first reference signal according to the unit time delay and outputs the carry digit corresponding to the time addition signal (S107).

According to the carry generation signal outputted from the carry digit processor 130, the multiplexer 140 can select an output signal of the reference adder 15 to output a carry digit signal corresponding to the time addition signal.

According to the example of the present invention, in order to solve the aforesaid problem, a time information-based adding apparatus can be achieved by storing time information according to a unit time delay using a time register.

Further, an easy and efficient addition with respect to multi bit can be conducted, and a precise carry digit processing can be achieved. Accordingly, the conventional digital-based information expression method can be replaced with a time-based information expression method by which multi-bit information can be expressed by a single voltage conversion. Further, multi-bit information can be transmitted and added through a single physical wire.

Accordingly, the example of the present invention can reduce a wire area of a circuit, which results in power efficiency improvement and resolution enhancement of a digital circuit, such as CMOS, as well as a reduction in the cost of production.

The method of adding according to the example of the present invention, as stated above, can conduct the addition of the time information to output the time addition signal and the carry digit signal, in the case that the first input signal and the second input signal indicate a predetermined multi-bit value corresponding to the integer multiple of the unit time delay value.

Meanwhile, the aforesaid method according to various examples of the present invention can be embodied as a program code to be provided to each server or equipment by being stored in various types of non-transitory computer readable medium.

A non-transitory computer readable medium is not a medium storing data for a short moment, such as a register, a cash and a memory, but a medium storing data semi-permanently and readable by an equipment. Specifically, the aforesaid various applications or programs can be provided by being stored in a non-transitory computer readable medium, such as CD, DVD, hard disc, Blueray disc, USB, memory card, and ROM.

Although the preferred examples of the present invention were illustrated and described above, the present invention is not limited to the aforesaid specific examples and can be variously modified by those skilled in the art without altering the gist of the invention defined in the claims. Such modified examples should not be understood individually from the technical idea or perspective of the present invention.

What is claimed is:

1. An adding apparatus using time information, comprising:
a time adder for outputting a time addition signal using time information of the first input signal and time information of the second input signal, if a first input signal synchronized according to a unit time delay and a second input signal synchronized with the unit time delay are applied; and
a carry digit processor for conducting a carry-lookahead operation corresponding to the time addition signal according to the unit time delay to output a carry generation signal.

2. The adding apparatus as claimed in claim 1, further comprising:
a reference adder for outputting a first reference signal and a second reference signal delaying the first reference signal according to the unit time delay; and
a multiplexer for outputting a carry digit corresponding to the time addition signal by selecting an output of the first reference signal or the second reference signal according to the carry generation signal.

3. The adding apparatus as claimed in claim 1, wherein the carry digit processor comprises:
a carry digit generation unit for outputting a carry digit generation value obtained from a time addition operation of the time adder according to the unit time delay;
a carry digit propagation unit for outputting a carry digit propagation value obtained from a time addition operation of the time adder according to the unit time delay; and
a carry digit output unit for outputting the carry generation signal corresponding to the time addition signal based on the carry digit generation value and the carry digit propagation value.

4. The adding apparatus as claimed in claim 1, wherein the time adder comprises at least a time register for storing time information of the first input signal and time information of the second input signal according to the unit time delay.

5. The adding apparatus as claimed in claim 1, wherein the first input signal and the second input signal indicate a predetermined multi-bit value corresponding to integer multiple of the unit time delay value.

6. The adding apparatus as claimed in claim 1, further comprising an input unit for converting a digital signal inputted from the outside into the first input signal or the second input signal synchronized with the unit time delay.

7. The adding apparatus as claimed in claim 1, further comprising a time-digital converter for outputting a digital-converted multi-bit addition signal according to the time added signal or the carry digit signal.

8. The adding apparatus as claimed in claim 1, further comprising a trigger signal input unit for inputting a trigger signal for the operation of the time adder or the reference adder.

9. A method of adding using time information of an adding apparatus, the method comprising the steps of:
outputting a time addition signal using time information of the first input signal and time information of the second input signal, if a first input signal synchronized according to a unit time delay and a second input signal synchronized with the unit time delay are applied; and
conducting a carry-lookahead operation corresponding to the time addition signal according to the unit time delay to output a carry generation signal.

10. The method of adding as claimed in claim 9, further comprising outputting a carry digit corresponding to the time addition signal by selecting an output of the first reference signal or the second reference signal of the reference adder for outputting the first reference signal and the second reference signal delaying the first reference signal according to the unit time delay.

11. The method of adding as claimed in claim 9, wherein the step of outputting the carry generation signal comprises the steps of:
outputting a carry digit generation value obtained from a time addition operation of the time adder according to the time delay;
outputting a carry digit propagation value obtained from a time addition operation of the time adder according to the unit time delay; and
outputting the carry generation signal corresponding to the time addition signal based on the carry digit generation value and the carry digit propagation value.

12. The method of adding as claimed in claim 9, wherein the first input signal and the second input signal indicate a predetermined multi-bit value corresponding to integer multiple of the unit time delay value.

13. A non-volatile recording medium storing a program to execute the method described in claim 9 in a computer.

14. A non-volatile recording medium storing a program to execute the method described in claim 10 in a computer.

15. A non-volatile recording medium storing a program to execute the method described in claim 11 in a computer.

16. A non-volatile recording medium storing a program to execute the method described in claim 12 in a computer.
